(19) United States
(12) Patent Application Publication
(10) Pub. No.: US 2016/0048873 A1
(43) Pub. Date: Feb. 18, 2016

(54) OBTAINING AN AD RELATED TO A SEARCH QUERY

(71) Applicant: Jordan Bayliss-McCulloch, Pyrmont (AU)

(72) Inventor: Jordan Bayliss-McCulloch, Pyrmont (AU)

(73) Assignee: Google Inc., Mountain View, CA (US)

(21) Appl. No.: 13/603,288

(22) Filed: Sep. 4, 2012

(51) Int. Cl. G06Q 30/02; G06F 17/30

(52) U.S. Cl. CPC G06Q 30/0256; G06F 17/30867

(57) ABSTRACT

Systems, methods, and machine-readable media for obtaining a content item from a content server. The system may be configured to transmit, to a content server, a request for a content item, the request comprising search terms, determine a first query characteristic based on the search terms, and transmit, to the content server subsequent to the transmitting of the request, the first query characteristic. The system may further be configured to receive the content item from the content server, wherein the content item was selected by the content server from a plurality of content items based on at least one of the search terms or the first query characteristic.

### FIELD

The present disclosure generally relates to the presentation of content to a user and, in particular, to identifying advertisements related to a search query.

### BACKGROUND

Search engines may be used to locate various resources on the Internet. For example, a user may submit a search query to a search engine and, in response to the search query, the search engine may generate a number of search results based on the search query and return the search results to the user.

Some search engines may derive revenue from selling space for advertisements (“ads”) and presenting the advertisements to users along with the search results. To reach a more responsive audience, advertisers and sellers of ad space have used various ways (e.g., demographic studies) to target particular ads to particular audiences. To this end, certain search engines may display advertisements that are related to a submitted search query. For example, a search engine may be configured to execute the search query received from the user and execute a second search to a back-end advertisement server for an advertisement related to the search query.

### SUMMARY

Various aspects of the subject technology relate to a system for obtaining a content item from a content server. The system may include one or more processors and a machine-readable medium comprising instructions stored therein, which when executed by the one or more processors, cause the one or more processors to perform operations. The operations may include receiving a search query comprising search terms from a client device, initiating, in response to receiving the search query, a request for an advertisement to an advertisement (ad) server, the request including the search terms from the search query, determining, subsequent to the initiating step and based on the search terms, a query type indicating a type of search results to be generated, and transmitting, to the ad server, the query type. The operations may further include receiving the ad from the ad server, wherein the ad was selected by the ad server from a plurality of ads based on at least one of the search terms or the query type.

Various aspects of the subject technology relate to a computer-implemented method for obtaining an advertisement from an advertisement server. The method may include receiving a search query comprising search terms from a client device, initiating, in response to receiving the search query, a request for an advertisement to an advertisement (ad) server, the request including the search terms from the search query, determining, subsequent to the initiating step and based on the search terms, a query type indicating a type of search results to be provided to the client device, transmitting, to the ad server, the query type, and receiving the ad from the ad server, wherein the ad was selected by the ad server from a plurality of ads based on at least one of the search terms or the query type.

Various aspects of the subject technology relate to a machine-readable medium including instructions stored therein, which when executed by a machine, cause the machine to perform operations for obtaining a content item from a content server. The operations may include initiating a request for an advertisement to an advertisement (ad) server, the request including search terms from a search query, determining, subsequent to the initiating step and based on the search terms, a query category indicating a type query received, transmitting, to the ad server, the query category, and receiving the ad from the ad server, wherein the ad was selected by the ad server from a plurality of ads based on at least one of the search terms or the query category.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed aspects and together with the description serve to explain the principles of the disclosed aspects.

FIG. 1 is a block diagram illustrating an example network environment in which a user may submit a search query and receive search results and an advertisement associated with the search query, in accordance with one aspect of the subject technology.

FIG. 2 is a conceptual block diagram illustrating an example system for obtaining advertisement from an advertisement server, in accordance with one aspect of the subject technology.

FIG. 3 is a flow chart illustrating an example process for obtaining an advertisement from an advertisement server, in accordance with one aspect of the subject technology.

FIG. 4 is a flow chart illustrating an example process for obtaining a content item from a content server, in accordance with one aspect of the subject technology.

FIG. 5 is a block diagram illustrating a computer system with which any of the clients, servers, computing devices, or systems described herein may be implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components are shown in block diagram form in order to avoid obscuring the concepts of the subject technology.

In order to identify advertisements that are related to a search query submitted by a user, a search engine may be configured to submit an advertisement (“ad”) request to a back-end ad server. The search engine may be configured to execute the user submitted search query and submit an ad request to the back-end ad server either in series or in parallel. Each strategy, however, has certain disadvantages.

In the parallel strategy, the search engine may receive a search query that includes search terms from a user. The search engine may include the search terms in an ad request and submit the ad request to an ad server in order to retrieve an ad related to the search query. At the same time, the search engine may use the search terms to execute the search query and generate search results for the user. However, submitting an ad request using only the search terms may result in sub-standard ads such as ads that are not closely related to a user's intended search or the search results because additional information is not used.

In the serial strategy, by processing the search query first, before submitting an ad request, the search engine may determine the type of query the user intends based on the search terms, obtain search results, and submit an ad request using the query type and the search results along with the search term. By using additional information elements to request an ad from the ad server, such as the query type, the search results, or any other query characteristics identified during the execution of the search query, the ad server may be better able to select ads that are related to the user's search query. However, executing the search query and submitting the ad request in series may cause an increase in execution time and latency experienced by the user.

According to one aspect of the subject technology, a system may be configured to stream information elements (e.g., search terms, query type, search results, search characteristics, etc.) related to the search query to an ad server as the information elements are obtained by the system so that the ad server may use the information elements to select one or more ads related to the search query.

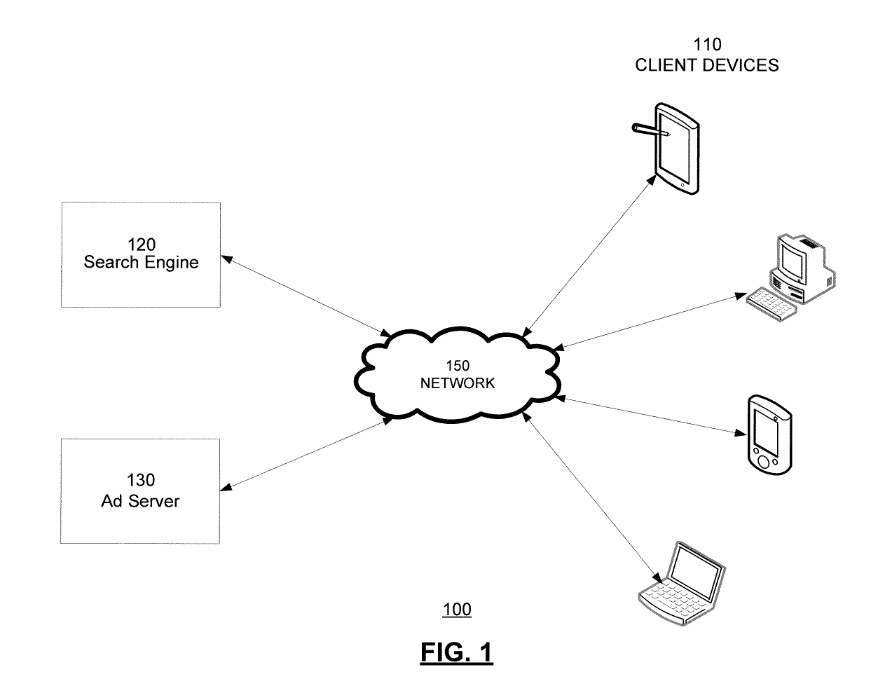

FIG. 1 is a block diagram illustrating an example network environment 100 in which a user may submit a search query and receive search results and an advertisement associated with the search query, in accordance with one aspect of the subject technology. The network environment 100 may include one or more client devices 110, a search engine 120, and an ad server 130 which may be in communication with one another over a network 150 such as the Internet. Although FIG. 1 illustrates a client-server network environment 100, other aspects of the subject technology may include other configurations including, for example, peer-to-peer environments or single system environments.

The client devices 110 may include, for example, desktop computers, mobile computers, tablet computers, mobile devices (e.g., a smart phone or a global positioning system (GPS) device), set top boxes (e.g., for a television), video game consoles, thin clients, televisions with one or more processors embedded therein and/or coupled thereto, or any other devices having appropriate processor, memory, and communications capabilities. The client devices 110 may be configured to run applications (e.g., a web browser, a mobile device application, or other application) that enables a user to submit a search query to a search engine 120.

The search engine 120, which may be hosted on a system or on one or more servers, may be configured to receive search queries from one or more client devices 110. In response to receiving a search query, the search engine 120 may process the search query in order to generate search results and respond to the client device 110 that send the search query with the search results.

In some cases, the search engine 120 may also transmit one or more advertisements (ads) that are related to the search query to the client device 110. In order to obtain an ad that is related to the search query, the search engine 120 may submit an advertisement (ad) request along with information related to the search query to an ad server 130.

The ad server 130, which may operate on a single computing device or be a virtual server made of a cluster of servers and back-ends, may be configured to select one or more ads for the search engine 120 based on the ad request and any other information related to the search query received from a search engine 120. There are several ways the ad server may select an ad for the search engine. For example, according to one aspect, the ad server 130 may search an index or database of ads based on key words or categories associated with the ads and the information about the search query provided by the search engine 120.

In many cases, however, the method implemented by the ad server 130 to select an ad may change over time as techniques are improved, as tweaks to the algorithm are made, or as more information is available to make the selection. However, by having the search engine 120 initiate an ad request and streaming information associated with the search query to the ad server 130 as the information becomes available, it is not necessary for the search engine 120 to be aware of how the ad server 130 selects an ad.

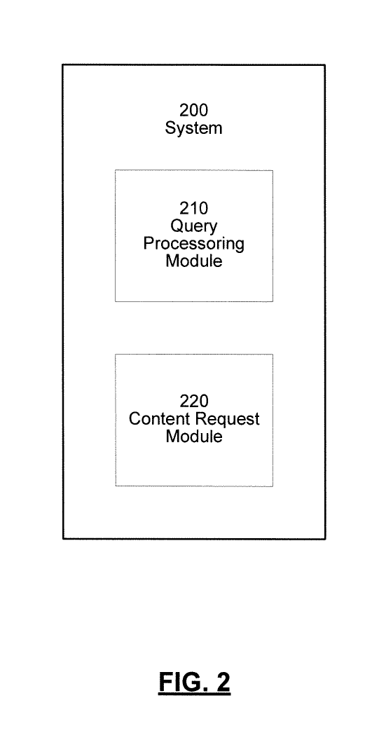

FIG. 2 is a conceptual block diagram illustrating an example system 200 for obtaining advertisement from an advertisement server, in accordance with one aspect of the subject technology. In one aspect, the system 200 may be a search engine such as the search engine 120 shown in FIG. 2, however, in other aspects, the system 200 is not limited to a search engine. While the system 200 is shown in one configuration in FIG. 2, in other configurations, the system 200 may include additional, alternative, and/or fewer components.

The system may include a query processing module 210 and a content request module 220. The query processing module 210 may be configured to receive queries and process the queries. According to one aspect, the query processing module 210 may receive a search query from a client device. The search query may include search terms and other information such as search parameters, location coordinates, or a user identifier for the user submitting the search query.

After receiving the search query, the query processing module 210 may process the search query. In some cases, processing the search query may include identify a number of query characteristics or other information elements associated with the search query. For example, based on the search terms in the search query, the query processing module 210 may determine that the search query is a web search for web documents, a local search for points of interest, or another search for other types of search results (e.g., restaurant reviews, maps, definitions for terms, etc.).

Using the query characteristics or other information elements, the query processing module 210 may execute the search and generate a number of search results. After the search results are generated, the query processing module 210 may transmit the search results back to the client device.

The system 200 may also be configured to transmit content items, such as advertisements, to the client device along with the search results. To that end, the content request module 220 may be configured to submit a content request to a content server. In one particular example, the content request module 220 may submit an ad request to a back-end ad server.

The ad server may be able to select one or more advertisements using various techniques and various pieces of information. For example, the ad server may be able to select one or more ads based on search terms, query characteristics, search results, or some other information element. In some aspects, the ad server may select advertisements using a combination of techniques and pieces of information. These techniques, however, may be unknown to the system 200 and the content request module 220.

The content request module 220 may be configured to transmit the pieces of information to the ad server as they become available. By transmitting pieces of information to the ad server as the information is available (e.g., in an asynchronous fashion), the system 200 enables the ad server to select one or more ads using the information. In other words, the ad server has the option and the ability to begin using various techniques to select ads using the available information. The ad server may begin the ad selection process using the pieces of information available to it and wait to use other techniques that may need additional pieces information until the additional pieces of information are provided by the content request module 220.

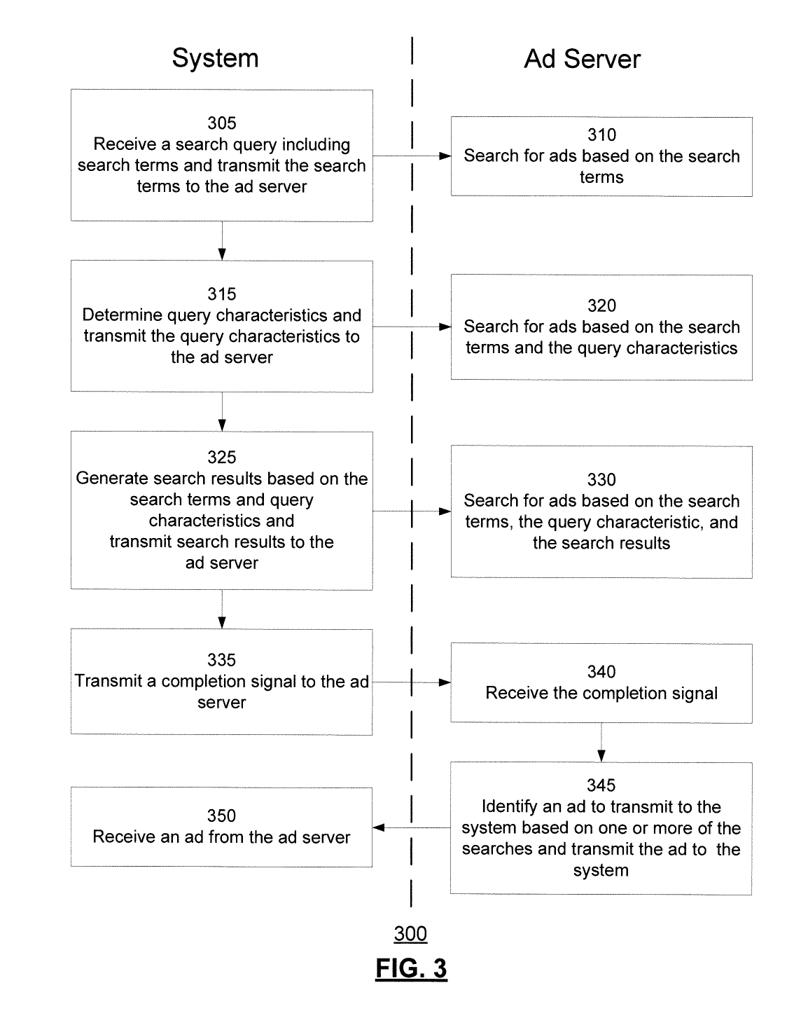

FIG. 3 is a flow chart illustrating an example process 300 for obtaining an advertisement (ad) from an advertisement (ad) server, in accordance with one aspect of the subject technology. Although the blocks in FIG. 3 are discussed with respect to the modules of system 200 illustrated in FIG. 2, the blocks are not limited to these modules. Furthermore, although the blocks are shown in one particular order, other orderings of blocks are also possible.

The process may involve the system 200 receiving a search query that includes search terms at block 305. Once the search query is received and the search terms are available to the system 200, the content request module 220 may initiate a request with the ad server for an ad and transmit the search terms to the ad server with the request. Once the ad server receives the search terms, at block 310, the ad server will have the option to begin searching for one or more ads based on the search terms.

After receiving the search query, the query processing module 210 may begin processing the search query. During the processing, the query processing module 210 may identify a number of query characteristics that may be useful in selecting an ad. The content request module 220 may then transmit these query characteristics to the ad server at block 315.

The query characteristics may include, for example, a query type, resources to be searched, user preferences, user search history, user behavior history, or any other information element identified during the processing of the search query that may be useful for the ad server. By sending the search characteristics as they are identified (e.g., in an asynchronous fashion), the ad server is given the ability, at block 320, to begin searching for one or more ads based on the search terms, the query characteristics identified by the query processing module 210, or a combination of these.

After the query characteristics have been identified, the query processing module 210 may generate search results based on the search terms and the query characteristics. At block 325, these search results may also be transmitted to the ad server so that the ad server has the ability to search for one or more ads based on the search terms, the search characteristics, the search results, or a combination of these at set 330. In one aspect, the search results may be streamed to the ad server as they are obtained by the query processing module 210. In another aspect, however, the search results may be transmitted to the ad server once all search results have been obtained.

Using the various information elements obtained from the system 200, the ad server may search for and select one or more ads and transmit the selected ad back to the system 200 or to a client device. In order to prevent lag, according to one aspect, the ad server may be instructed to return an ad selection to the system 200 by a completion signal regardless of whether the ad server has finished all ad selection processes. The completion signal may be triggered by a timer on the system 200 or on the ad server.

For example, in FIG. 3, the system 200 may have initiated a timer at some point during the search query processing (e.g., when the search query was received from the client or after search results were generated). When the timer expires, at block 335, the content request module 220 may be configured to transmit a completion signal to the ad server. The completion signal will indicate to the ad server that a selection of an ad should be transmitted back to the system 200 as soon as possible.

At block 340, the ad server may receive the completion signal and, at block 345, identify an ad to transmit to the system based on one or more of the searches 310, 320, or 330. The ad may then be transmitted to the system 200 where, once the ad is received at block 350, the ad may be sent to a client device along with the search results. In some cases, not every search 310, 320, or 330 may have completed before the completion signal was received. However, the ad server may still select an ad and transmit it to the system 200 in response to receiving the completion signal without having completed all the searches.

According to one aspect, the communications between the system and the ad server may occur via a communications channel (e.g., a streaming remote procedure call (RPC)) created between the system and the ad server. In other aspects, however, the communications may occur via multiple communications and transmissions.

Although FIG. 3 discusses obtaining an advertisement from an ad server, in other embodiments, other content items may be requested from other servers as well. The content items may include any type of information that may be presented to a user such as, for example, visual media (e.g., pictures, text, video, or a combination), interactive interface elements, or other media such as an audio transmissions that includes an audible message that may be played on a client device.

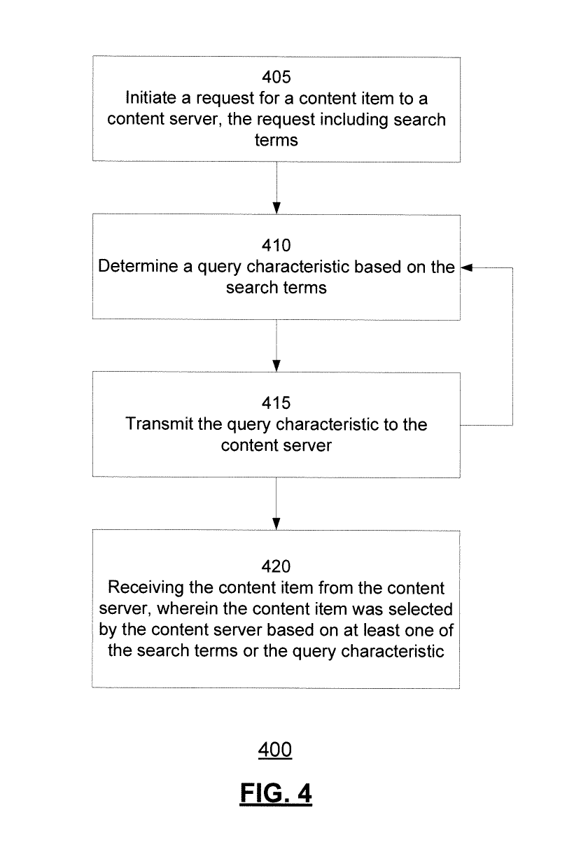

FIG. 4 is a flow chart illustrating an example process 400 for obtaining a content item from a content server, in accordance with one aspect of the subject technology. Although the blocks are shown in one particular order, other orderings of blocks are also possible.

The process may involve a system configured to perform a search based on a search query as well as retrieve a content item from a content server. At block 405, the system may initiate a request for a content item (e.g., an advertisement) to a content server. The request for the content item may include the search terms associated with the search query.

After the request for the content item is sent to the content server and during the processing of the search query, the system may determine a query characteristic based on the search terms. For example, if one of the search terms includes a point of interest name (e.g., a city name) the system may determine that the search query is of a “local search” type. The system may also determine that the search query is a “local search” type if the search terms include “where is,” “find the nearest,” “location of,” or some other combination of keywords.

Once the query characteristic is determined, it may be transmitted to the content server at block 415. According to one aspect of the subject technology, additional query characteristics may also be determined and transmitted to the content server in a similar fashion. The query characteristics may include, for example, additional query types, search results, user information (e.g., profile information or user history for the user that submitted the search query), resources to be searched, keywords or phrases that characterize a user's interests, keywords or phrases that characterize the search query, or any other information element identified during the processing of the search query that may be useful for the ad server.

At some point after one or more query characteristics are transmitted to the content server, at block 420, the system may receive a content item from the content server that was selected based on the search terms, the one or more query characteristics, or a combination of the information transmitted to the content server.

As indicated above with respect the aspect illustrated in FIG. 3, the system may receive the content item in response to a completion signal being sent. In another aspect, the system may receive the content item at any point after the request for the content item is sent to the content server, regardless of whether or not the system has finished processing the search query or regardless of what query characteristics have been sent to the content server.

Although certain aspects discussed herein relate to a system processing a search query submitted by a user, in other aspects, the system may be configured to perform other functions. While performing these other functions, the system may identify information elements related to the functions and transmit these information elements to the content server to aid the content server in identifying a content item related to the function.

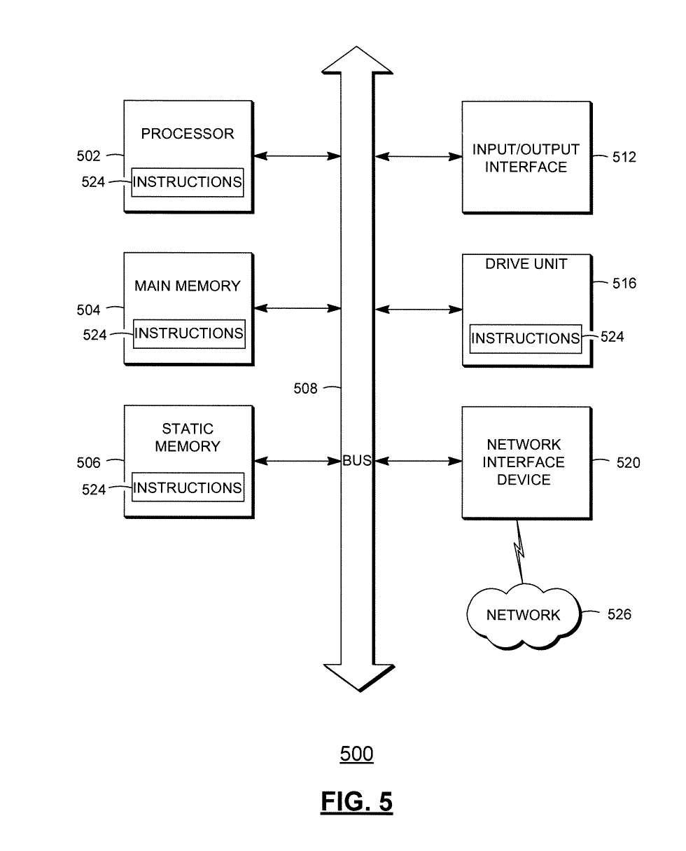

FIG. 5 is a block diagram illustrating a computer system 500 with which any of the clients, servers, computing devices, or systems described herein may be implemented. In certain aspects, the computer system 500 may be implemented using hardware or a combination of software and hardware, either in a dedicated server, or integrated into another entity, or distributed across multiple entities.

The example computer system 500 includes a processor 502, a main memory 504, a static memory 506, a disk drive unit 516, and a network interface device 520 which communicate with each other via a bus 508. The computer system 500 may further include an input/output interface 512 that may be configured to communicate with various input/output devices such as video display units (e.g., liquid crystal (LCD) displays, cathode ray tubes (CRTs), or touch screens), an alphanumeric input device (e.g., a keyboard), a cursor control device (e.g., a mouse), or a signal generation device (e.g., a speaker).

Processor 502 may be a general-purpose microprocessor (e.g., a central processing unit (CPU)), a graphics processing unit (GPU), a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

A machine-readable medium (also referred to as a computer-readable medium) may store one or more sets of instructions 524 embodying any one or more of the methodologies or functions described herein. The instructions 524 may also reside, completely or at least partially, within the main memory 504 and/or within the processor 502 during execution thereof by the computer system 500, with the main memory 504 and the processor 502 also constituting machine-readable media. The instructions 524 may further be transmitted or received over a network 526 via the network interface device 520.

The machine-readable medium may be a single medium or multiple media (e.g., a centralized or distributed database, and/or associated caches and servers) that store the one or more sets of instructions. The machine-readable medium may comprise the drive unit 516, the static memory 506, the main memory 504, the processor 502, an external memory connected to the input/output interface 512, or some other memory. The term “machine-readable medium” shall also be taken to include any non-transitory medium that is capable of storing, encoding or carrying a set of instructions for execution by the machine and that cause the machine to perform any one or more of the methodologies of the embodiments discussed herein. The term “machine-readable medium” shall accordingly be taken to include, but not be limited to, storage mediums such as solid-state memories, optical media, and magnetic media.

Systems, methods, and machine-readable media for obtaining a content item from a content server. The system may be configured to transmit, to a content server, a request for a content item, the request comprising search terms, determine a first query characteristic based on the search terms, and transmit, to the content server subsequent to the transmitting of the request, the first query characteristic. The system may further be configured to receive the content item from the content server, wherein the content item was selected by the content server from a plurality of content items based on at least one of the search terms or the first query characteristic.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system.

Skilled artisans may implement the described functionality in varying ways for each particular application. For example, the modules may include software instructions encoded in a medium and executed by a processor, computer hardware components, or a combination of both. The modules may each include one or more processors or memories that are used to perform the functions described below. According to another aspect, the various systems and modules may share one or more processors or memories. Various components and blocks may be arranged differently (e.g., arranged in a different order, or partitioned in a different way) all without departing from the scope of the subject technology.

It is understood that the specific order or hierarchy of blocks in the processes disclosed is an illustration of exemplary approaches. Based upon design preferences, it is understood that the specific order or hierarchy of blocks in the processes may be rearranged. Some of the blocks may be performed simultaneously.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such a configuration may refer to one or more configurations and vice versa.

The word “exemplary” may be used herein to mean “serving as an example or illustration.” Any aspect or design described herein as “exemplary” is not necessarily to be construed as All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

1. A computer-implemented method for obtaining an advertisement from an advertisement server, the method comprising:
receiving, using one or more computing devices, a search query comprising search terms from a client device;
transmitting, using the one or more computing devices, in response to receiving the search query, a request for an advertisement to an advertisement (ad) server, the request including the search terms from the search query;
determining, using the one or more computing devices, subsequent to the transmitting step and based on the search terms, a query type indicating a type of search results to be provided to the client device;
transmitting to the ad server, using the one or more computing devices, subsequent to the determining step, the query type as determined from the search terms, so that the ad server begins searching for the ad based on at least one of the search terms or the query type;
transmitting to the ad server, using the one or more computing devices, a completion signal;
receiving, using the one or more computing devices, the ad from the ad server, wherein the ad was selected by the ad server from a plurality of ads based on at least one of the search terms or the query type, and wherein the ad is provided by the ad server in response to receiving the completion signal regardless of whether the ad server finished all ad selection processes based on the search terms and the query type.

2. The computer-implemented method of claim 1, wherein the determining step occurs while the ad server processes the request for the advertisement.

3. The computer-implemented method of claim 1, further comprising:
creating a communications channel with the ad server, and wherein the request for the ad and the query type are transmitted to the ad server via the communications channel.

4. The computer-implemented method of claim 1, further comprising:
determining, using the one or more computing devices, a query characteristic associated with the search query; and
transmitting, using the one or more computing devices, subsequent to the transmitting of the query type, the query characteristic to the ad server.

5. The computer-implemented method of claim 4, wherein the query characteristic comprises search results for the search query generated based on the search terms and the query type.

6. The computer-implemented method of claim 5, wherein the ad was selected by the ad server from a plurality of ads based on at least one of the search terms, the query type or the query characteristic.

7. The computer-implemented method of claim 4, wherein the transmitting a completion signal to the ad server occurs subsequent to the transmitting the query characteristic to the ad server.

8. The computer-implemented method of claim 7, wherein the ad is provided by the ad server in response to receiving the completion signal regardless of whether the ad server finished all ad selection processes based on the search terms, the query type and the query characteristic.

9. A system for obtaining a content item from a content server, the system comprising:
one or more processors; and
a non-transitory machine-readable medium comprising instructions stored therein, which when executed by the one or more processors, cause the one or more processors to perform operations comprising:
receiving a search query comprising search terms from a client device;
initiating, in response to receiving the search query, a request for a content item to a content server, the request including the search terms from the search query;
determining, subsequent to the initiating step and based on the search terms, a query type indicating a type of search results to be generated;
transmitting, to the content server, subsequent to the determining step, the query type, so that the content server begins searching for a content item based on at least one of the search terms or the query type;
transmitting to the ad server, using the one or more computing devices, a completion signal;
receiving the content item from the content server, wherein the content item was selected by the content server from a plurality of content items based on at least one of the search terms or the query type, and wherein the content item is provided by the content server in response to receiving the completion signal regardless of whether the content server finished all content selection processes based on the search terms and the query type.

10. The system of claim 9, wherein the determining step occurs while the content server processes the request for the content item.

11. The system of claim 9, wherein the operations further comprise:
creating a communications channel with the content server, and wherein the request for the content item and the query type are transmitted to the content server via the communications channel.

12. The system of claim 9, wherein the operations further comprise:
determining, subsequent to the transmitting of the query type, a query characteristic associated with the search query; and
transmitting the query characteristic to the content server.

13. The system of claim 12, wherein the query characteristic comprises search results.

14. The system of claim 12, wherein the query characteristic comprises keywords associated with the search terms.

15. The system of claim 12, wherein the transmitting a completion signal to the content server occurs subsequent to the transmitting the query characteristic to the content server, and wherein the content item is provided by the content server in response to receiving the completion signal regardless of whether the content server finished all content selection processes based on the search terms, the query type and the query characteristic.

16. The system of claim 9, wherein the system and the content server are on a same machine.

17. A non-transitory machine-readable medium comprising instructions stored therein, which when executed by a machine, cause the machine to perform operations comprising:
initiating a request for an advertisement to an advertisement (ad) server, the request including search terms from a search query;
determining, subsequent to the initiating step and based on the search terms, a query category indicating a type of query received;
transmitting, to the ad server, subsequent to the determining step and before a step of generating search results, the query category; and
receiving the ad from the ad server, wherein the ad was selected by the ad server from a plurality of ads based on at least one of the search terms or the query category.

18. The non-transitory machine-readable medium of claim 17, wherein the operations further comprise:
receiving the search query comprising the search terms from a client device; and
wherein the request for the advertisement is initiated based on the receiving of the search query.

19. The non-transitory machine-readable medium of claim 17, wherein the operations further comprise:
generating, subsequent to the transmitting of the query category, search results based on the search terms and the query category; and
transmitting the search results to the ad server.

20. The non-transitory machine-readable medium of claim 17, wherein the operations further comprise transmitting a completion signal to the ad server, and wherein the ad is received from the ad server in response to the ad server receiving the completion signal.
